(19) United States
(12) Patent Application Publication
(10) Pub. No.: US 2001/0049733 A1
(43) Pub. Date: Dec. 6, 2001

(54) Content distribution system

(76) Inventors: Hiroshi Tokumaru, Kyoto-city (JP); Hiroshi Yoshida, Tokyo (JP); Kouichi Ozawa, Kyoto-city (JP)

Correspondence Address: SHAW PITTMAN, 2300 N STREET, N.W., WASHINGTON, DC, 20037-1128, US

(21) Appl. No.: 09/821,030

(22) Filed: Mar. 30, 2001

(30) Foreign Application Priority Data
Mar. 31, 2000 (JP) 2000-096814
Mar. 31, 2000 (JP) 2000-096843

(51) Int. Cl. G06F 15/16; G06F 15/173

(52) U.S. Cl. 709/225; 709/218

(57) ABSTRACT

A content distribution system, capable of creating content and changing itself easily, is provided. In a content server 30, contents created by data written in the basic language, which can easily be converted into other languages, are stored. The content server 30 identifies the type of a terminal device accessing thereto. Content being requested is converted into data written in a display language appropriate for the terminal device on a real time basis and the resultant data is transmitted to the terminal device. At the terminal device, display according to the display language data is carried out.

### CROSS REFERENCE TO RELATED APPLICATIONS

All the contents disclosed in Japanese Patent Application Nos. 2000-96814 and 2000-96843 (both filed on Mar. 31, 2000), including specification, claims, drawings and abstract and summary are incorporated herein by reference in its entirety.

### FIELD OF THE INVENTION

This invention relates to a technique by which content can be distributed appropriately to computers and/or mobile phones, which use different display formats.

### BACKGROUND OF THE INVENTION

FIG. 1 shows a conventional content distribution system. In the system, each of terminals 2,4,6,8,and 10 in different type may access to each of corresponding servers 14, 16, 18, 20, and 22 via the Internet 12.

The personal computer (hereinafter referred to as PC) 2 which use a browser program for access, however, can only perform appropriate display when it retrieves data written in HTML (Hyper Text Markup Language) from the server 14. This is, because data description languages for the servers 16, 18, 20, and 22 are different thereamong. Similarly, at an i-mode (trademark) terminal 4, appropriate display can only be performed when the terminal accesses with the C-HTML (Compacted Hyper Text Markup Language) server 16. i-mode is mobile internet access services in Japan, by which contents on the Internet can be viewed using a browser equipped in its mobile phones as terminals. In addition, a WAP (trademark) terminal 6, a Personal Handyphone System (hereinafter referred to as PHS) terminal 8, and a terminal 10 for personal computer communications service need to access respectively with an HDML (Handheld Device Markup Language) server 18, the server 20 for PHS, and the server 22 for personal computer communications service in order to perform appropriate display thereon.

Thus, users of such terminals need to change one of the severs depending on the type of the terminals even when all the users try to access to the identical content.

Also, when a desired content is available solely in a specific language that differs from a language used by the terminal, the user thereof can not view that content.

Suppliers of content, in contrast, need to prepare contents written in many different languages and they have to provide servers for storing these contents in order to make the contents to be viewed by many users.

It is, therefore, creation of the contents, maintenance, and updating thereof require a lot of work to the suppliers.

It is an object of the present invention to provide a server for distributing content, by which suitable content for each of terminals is distributed without providing servers for each of the terminals. There is a demand for a system implementing conversion among different languages under such circumstances. The aim of the present invention is, to solve the problems described above, and to provide a language converting system, which facilitate creation of content and update thereof.

### SUMMARY OF THE INVENTION

(1) In accordance with characteristics of the present invention, there is provided a content distribution server, the server transmitting content upon receipt of an access to the system from different types of terminal devices,

wherein the content is stored in the content distribution server, and the system identifies a type of the terminal device which have requested for the content along with changing contents of processing by which the content is distributed depending on the type of the terminal when the content distribution processing is performed according to the stored content.

In this way, appropriate content can be provided to a terminal device in response to the type thereof.

(2) In the content server according to the present invention, the content server receiving accesses from terminal devices, each using different display language, the content server comprising:

content storage means, storing content created by data written in a basic language;

terminal type identifying means, identifying a type of the terminal device accessing to the server; and

language conversion and transmission means, reading out the content stored in the content storage means, converting the display language used for the content into an appropriate display language for performing display on the terminal device, and transmitting the converted content to the terminal device.

Thus, content which is displayed properly, can be provided to different types of the terminal devices by just preparing contents written in the basic language in the content server. This will lighten the burden imposed on the creator of the content, and it is not necessary for the users to change content servers for access depending on the type of the terminals.

(5) In accordance with characteristics of the present invention, there is provided a content server in which the terminal type identifying means identifies the type of the terminal device in accordance with an header of Hyper Text Transfer Protocol (HTTP) sent from the terminal.

Thus, the display language used by the terminal device can accurately be identified and this result in performing appropriate processing to different types of the terminal devices because the HTTP header indicates the protocol used by the terminal device.

(6) In accordance with characteristics of the present invention, there is provided a content server in which the terminal identifying means identifies the type of the terminal device in accordance with an IP address of the terminal device when it accesses to the server.

Type of the terminal devices can be identified accurately because the way of assigning IP addresses is unique among communication common carriers that define the type of the terminal devices. Therefore, appropriate processing can be performed for different types of the terminal devices.

(7) In accordance with characteristics of the present invention, there is provided a content server in which information in the data written in the basic language which is required for performing display on the terminal device is separated into display contents description data indicative of what is to be displayed and display format description data indicative of a display format of the display,

and wherein the data written in the basic language includes at least the display contents description data and the display format description data necessary for performing display.

Data conversion from the data written in the basic language (hereinafter referred to as basic language data) can be performed quickly because the basic language data is separated into the display contents description data indicative of what is to be displayed and the display format description data indicative of a display format of the display, and the basic language data includes at least the display contents description data and the display format description data necessary for performing display.

(8) In accordance with characteristics of the present invention, there is provided a content server in which the display format description data includes description indicating a display format of each of the display contents corresponding to each of the display contents described in the display contents description data.

Consequently, accurate display can be realized as a result of performing the data conversion without losing its display format for each of the display contents.

(9) In accordance with characteristics of the present invention, there is provided a content server, in which the description indicating the display format includes an elliptical symbol, which shows that the description is a predetermined display format.

In this way, the description of display formats frequently used can be simplified and this result in simplicity in the data structure of the basic language data.

(10) In accordance with characteristics of the present invention, there is provided a method of distributing content on receipt of an access to the system from different types of terminal devices, the method comprising the steps of:

storing the content;

identifying a type of the terminal device which have requested for the content; and

changing contents of processing by which the content is distributed depending on the type of the terminal when the content distribution processing is performed according to the stored content.

In this way, appropriate content can be provided to a terminal device in response to the type thereof.

(11) In the a language conversion system according to the present invention, the language conversion system for converting one arbitrary display language referring to as a conversion source display language out of different display languages used for performing display on different types of terminal devices into another arbitrary display language, the system comprising:

display language data storage means, storing data written in the conversion source display language;

first conversion processing means, converting the data written in the conversion source display language stored in the display language data storage means into data written in a basic language, the first conversion processing means separating the conversion source display language data into display contents description indicative of what is to be displayed and display format description indicative of a display format of the display as a result of performing an analysis of the data written in the conversion source display language, and the data written in the basic language including at least display contents description data and the display format description data necessary for performing display;

basic language data storage means, storing the data written in the basic language; and

second conversion processing means, generating another display language data by determining display contents according to the display contents description data in the basic language data stored in the basic language data storage means and by determining the display format according to the display format description data.

Less programs in number for performing conversion processing are required compared to the method directly converting data written in an arbitrary display language into another arbitrary display language because the method according to the present invention performs the conversion through a step for once converting the former data into basic language data. Further, the conversion into the basic language and from that language can be performed easily because the basic language data is separated into display contents description indicative of what is to be displayed and display format description indicative of a display format of the display, and the basic language data includes at least display contents description data and the display format description data necessary for performing display. In addition, the basic language can be modified to a language easy to use for language conversion.

(12) In accordance with characteristics of the present invention, there is provided a language conversion system for converting different display languages used for performing display on different types of terminal devices into a basic language, the system comprising:

display language data storage means, storing data written in the display languages; and

conversion processing means, converting the data written in the display language stored in the display language data storage means into data written in written in the basic language;

wherein the conversion processing means separates the data written in the display language into display contents description indicative of what is to be displayed and display format description indicative of a display format of the display as a result of performing an analysis of the data written in the display language, and the data written in the basic language includes at least display contents description data and display format description data necessary for performing display.

In this way, some data each written in different kind of display language can be converted into basic language data commonly used. Also, the conversion into the basic language can be performed easily because the basic language data is separated into display contents description indicative of what is to be displayed and display format description indicative of a display format of the display, and the basic language data includes at least the display contents description data and the display format description data necessary for performing display.

(15) In accordance with characteristics of the present invention, there is provided a language conversion system, wherein the conversion processing means generates data written in the basic language not including the display format description data when the display format of a display language which to be converted is in a basic display format.

The structure of the basic language data thus generated become simple.

(16) In accordance with characteristics of the present invention, there is provided a language conversion system, wherein the display format description data includes description indicating a display format of each of the display contents corresponding to each of the display contents described in the display contents description data.

Consequently, the data conversion can be performed without losing its display format for each of the display contents.

(17) In accordance with characteristics of the present invention, there is provided a language conversion system wherein the description indicating the display format includes an elliptical symbol, which shows that the description is a predetermined display format.

In this way, the description of display formats frequently used can be simplified and this result in simplicity in the data structure of the basic language data.

(18) In accordance with characteristics of the present invention, there is provided a method of converting data written in a language for output which is subject to conversion into data written in a basic language, the method being used for converting data written in different languages for output by different types of devices into data written in one common basic language, the method comprising the step of:

separating the data written in the output language into output contents description indicative of what is to be output and output format description indicative of an output format of the output data as a result of performing an analysis of the data written in the output language, and the data written in the output language including at least output contents description data and output format description data necessary for performing output.

In this way, some data each written in different kind of output language can be converted into basic language data commonly used. Also, the conversion into the basic language can be performed easily because the basic language data is separated into the output contents description indicative of what is to be output and the output format description indicative of an output format of the output, and the basic language data includes at least the output contents description data and the output format description data necessary for performing output.

(19) In accordance with characteristics of the present invention, there is provided a language conversion system for generating data written in multiple different languages for performing display on different types of terminal devices according to one basic language, the system comprising:

basic language data storage means, storing data written in the basic language; and

conversion processing means, converting the data written in the basic language data stored in the basic language data storage means into data written in the display language;

wherein information in the data written in the basic language which is required for performing display on the terminal device is separated into display contents description data indicative of what is to be displayed and display format description data indicative of a display format of the display,

and wherein the data written in the basic language includes at least the display contents description data and the display format description data necessary for performing display.

Thus, a plurality of display languages different in kind can be created by just creating the data written in the basic language. Further, the conversion from the basic language can be performed easily because the basic language data is separated into display contents description indicative of what is to be displayed and display format description indicative of a display format of the display, and the basic language data includes at least the display contents description data and the display format description data necessary for performing display.

(22) In accordance with characteristics of the present invention, there is provided a language conversion system, wherein the conversion processing means carries out the conversion so that a display format of the data is in a standard display format in the display language to be converted when no display format description data is included in the data written in the basic language.

In this way, the data structure of the basic language data and this result in performing the conversion from the basic language easily.

(23) In accordance with characteristics of the present invention, there is provided a language conversion system, wherein the display format description data includes description indicating a display format of each of the display contents corresponding to each of the display contents described in the display contents description data.

Consequently, the data conversion can be performed without losing its display format for each of the display contents.

(24) In accordance with characteristics of the present invention, there is provided a language conversion system, wherein the description indicating the display format includes an elliptical symbol, which shows that the description is a predetermined display format.

In this way, the description of display formats frequently used can be simplified and this result in simplicity in the data structure of the basic language data.

(25) In accordance with characteristics of the present invention, there is provided a method of converting data written in a basic language being retrieved which is subject to conversion into data written in a language

for output, the method being used for converting the data written in the basic language into data written in multiple different languages for outputting by different types of terminal devices according to one basic language,

wherein information, contained in the data written in the basic language which is required for performing output by the terminal device, is separated into output contents description data indicative of what is to be output and output format description data indicative of an output format,

and wherein the data written in the basic language includes at least output contents description data and output format description data necessary for performing output.

Thus, just creating the basic language data can generate data written in multiple output languages different in kind. Further, the conversion from the basic language can be performed easily because the basic language data is separated into the output contents description indicative of what is to be output and the output format description indicative of an output format of the output data, and the basic language data includes at least the output contents description data and the output format description data necessary for performing output.

The term “different types of terminal devices” in this invention refers to terminals in which how to perform processing for the content written in a display language therefor and so on is different from one another. Each of the terminals not just contains different software but has different hardware structure.

The term “display contents description data” refers to data mainly representing characters, pictures and so on displayed on the terminals or data formed of file names and so on of the original data In the embodiments described herein, data in the body corresponds thereto.

The term “display format description data” refers to data mainly describing how to display images on the terminals. In the embodiments described herein, style sheet corresponds thereto.

The term “terminal type identifying means” refers to means for identifying the type of a terminal in some way. It includes a concept in which, for example, the type of a terminal device is identified one of according to an HTTP header or an IP address of the terminal device or by detecting the type of line(s) used for connection. It further includes a concept in which the type of a terminal device is identified as a result of receiving information indicting its type from the terminal device.

Other objects and features of the present invention will be more apparent to those skilled in the art on consideration of the accompanying drawings and following specification, in which are disclosed several exemplary embodiments of the present invention. It should be understood that variations, modifications and elimination of parts may be made therein as fall within the scope of the appended claims without departing from the spirit of the invention.

### BRIEF DESCRIPTION OF THE DRAWINGS

FIG. 1 is a diagram of a conventional content distribution system;

FIG. 2a is a diagram showing an example of hardware of a content distribution system according to the present invention;

FIG. 2b is a diagram showing another example of hardware of the content distribution system according to the present invention;

FIG. 3 is a diagram showing the overall structure of basic language data;

FIG. 4 is a diagram showing the structure of the basic language data;

FIG. 5 is a diagram showing the structure of tags in the basic language data;

FIG. 6 is a diagram showing an example of the body of the basic language;

FIG. 7 is a diagram showing an example of a style sheet of the basic language;

FIG. 8 is a flowchart of the processes performed by a content distribution server for distributing content;

FIG. 9 is a flowchart of a program for identifying the type of terminals;

FIG. 10 is a flowchart of a program for converting a language into another language;

FIG. 11 is a diagram showing the structure of the basic language data;

FIG. 12 is a view showing the tree structure of the basic language data;

FIG. 13 is a view showing the tree structure of the basic language data;

FIG. 14 is a view showing data converted into the tree structure;

FIG. 15 is a view showing data converted into the tree structure;

FIG. 16 is a flowchart of a program for converting basic language data into HTML data;

FIG. 17 is a view showing the converted HTML data;

FIG. 18 is a diagram showing an image displayed on the screen with the HTML data shown in FIG. 17;

FIGS. 19a, 19b are flowcharts of a program for converting basic language data into HDML data;

FIG. 20 is a view showing the HDML data thus converted;

FIG. 21 is a diagram showing an image displayed on the screen with the HDML data show in FIG. 20;

FIG. 22 is a diagram showing a content distribution system according to the present invention in another embodiment;

FIG. 23 is a diagram showing a content distribution system according to the present invention in another embodiment;

FIG. 24 is a diagram showing a content distribution system according to the present invention in another embodiment; and

FIG. 25 is a diagram showing a content distribution system according to the present invention in another embodiment.

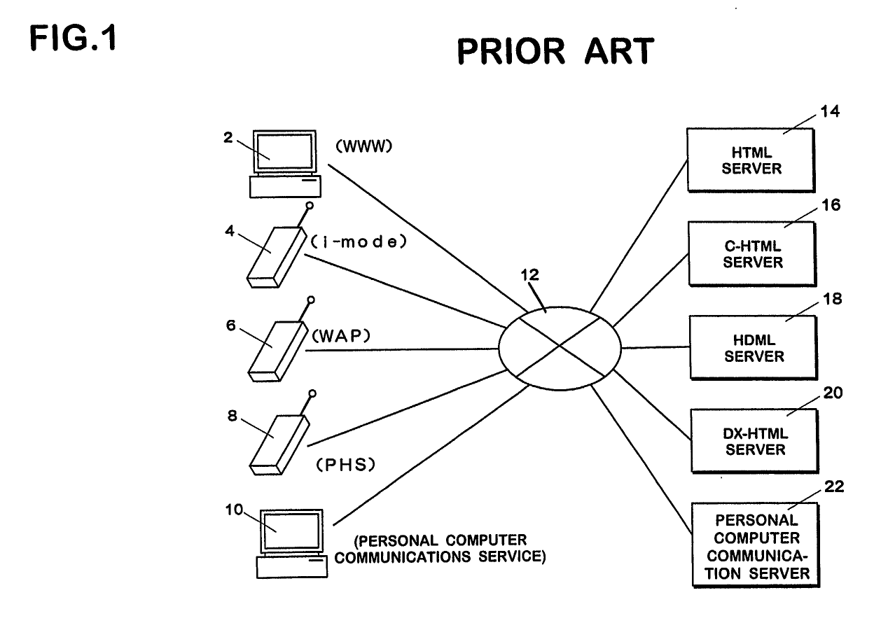

### DETAILED DESCRIPTION OF THE INVENTION

1. Content distribution system

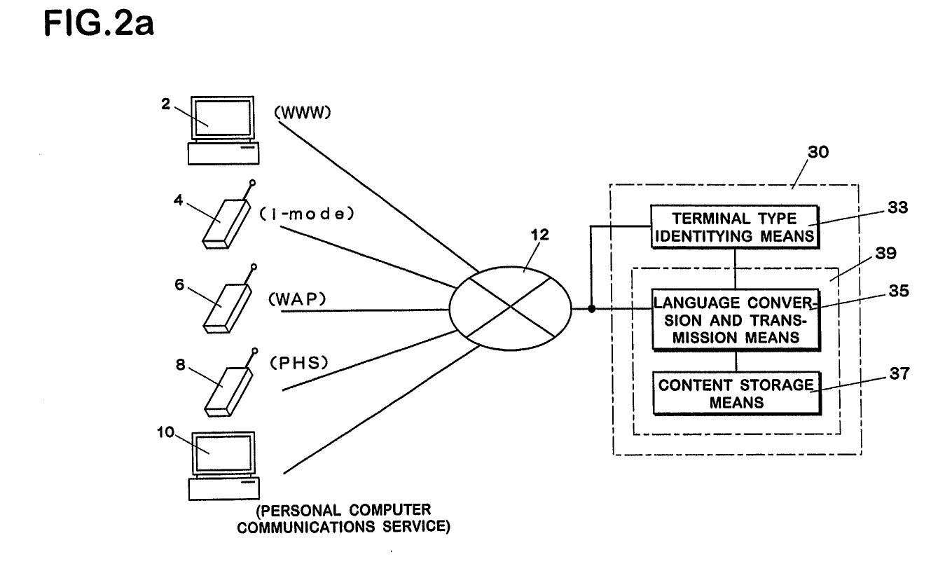

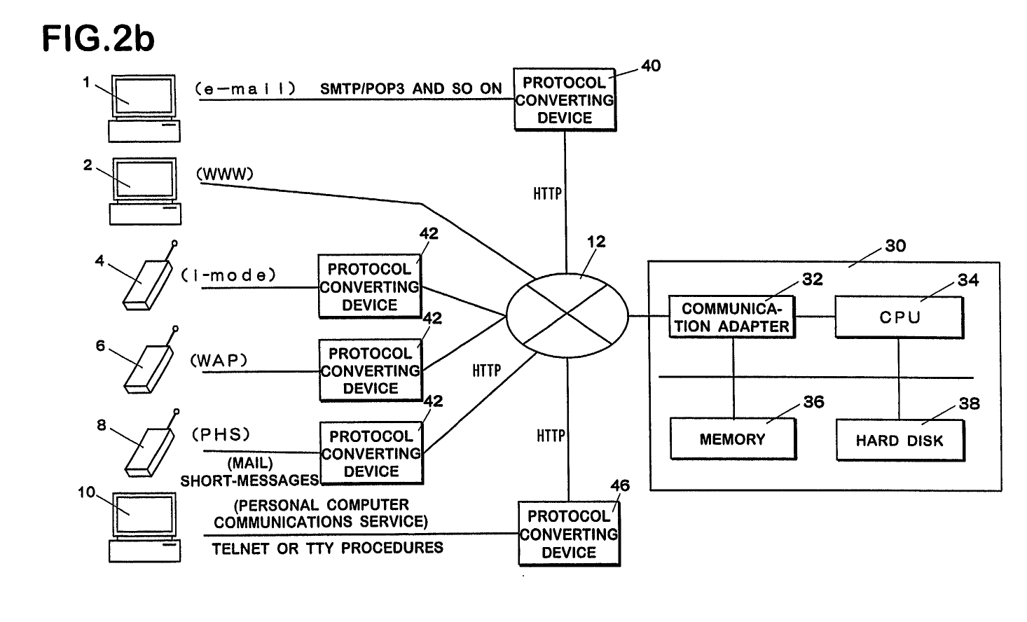

An example of a content distribution system according to the present invention is depicted in FIG. 2a. Connected to the Internet 12 is a server 30 for distributing content (hereinafter referred to as content server). Also, terminal devices 2, 4, 6, 8, and 10 each different in type such as a personal computer 2 which equips World Wide Web, an i-mode (trademark) terminal, a terminal for WAP(Wireless Application Protocol) (trademark), a PHS terminal, and a PC for personal computer communications service, are connectable with the Internet 12.

The personal computer (hereinafter referred to as PC) 2 is accessible with the content server 30 via a protocol converting device 40 in an electric-mail format (that is, in SMTP/POP3). The PC 2 is also accessible with the content server 30 using browser software (that is, in http protocol). Further, mobile phones 4, 6, and 8 are respectively accessible with the content server 30 via protocol converting devices 42 and 44 (see FIG. 2b) in the forms of “i-mode”, “WAP”, and electric mail”. The PC 10 is accessible with the content server 30 via a protocol converting device 46.

The content server 30 comprises terminal type identifying means 33 for identifying the type of terminals and terminal support processing means 39 for changing content of content distributing processing depending on the type of the terminal identified. In this embodiment, the terminal support processing means 39 comprises content storage means 37 for storing contents written in the basic language and language conversion and transmission means 35 for converting the content stored in the content storage means 37 into content written in a language appropriate to the terminal accessing and transmitting the converted content to the terminal upon receipt of the terminal type identified.

The language conversion and transmission means 35 transmits the requested content to the terminal while performing conversion of its language into another on a real time basis.

FIG. 2b is a diagram showing the overall system and a block diagram of the hardware for the content server 30. The content server 30 comprises a communication adapter 32 for connecting into the Internet 12, a CPU 34, a memory 36, and a hard disk 38. Stored in the hard disk 38 are the operating system (such as UNIX etc.), a program for identifying terminals, a program for converting language and so on. In addition, content written in the basic language is stored therein. The terminal type identification program performs a process in which type of the terminal accessing is identified by collaborating with the operating system. Also, the language conversion program carries out a process in which the basic language data is converted into the data written in a language appropriate to the display language used with each of the terminals.

2. Structure of basic language data

(1) Overall stricture

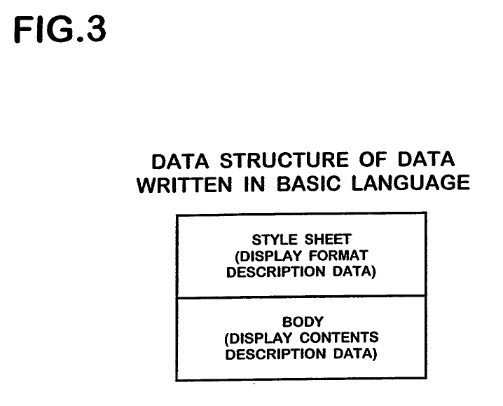

In this embodiment, data of the content stored in the hard disk 38 is written in the basic language. FIG. 3 shows the structure of such data. The basic language data comprises a style sheet (display format description data) describing a display format thereof and the body representing the contents of displays (display contents description data). The style sheet is a part describing color for display, size of characters, display formats and so on. The body is a part representing a text describing its contents. The style sheet, however, is provided to the data optionally. It is meant that the data will be displayed in the standard format when none of the style sheet is provided.

In this embodiment, the body of the data is common regardless of the display language after conversion in language, but the style sheet is unique to the display language after the conversion. Thus, it is necessary to provide a style sheet for data each written in HTML and HDML respectively when the display format of these data other than the standard format is desired.

Hence, when a style sheet just for the HTML data is provided therefor, the standard display format is employed on the HDML data during conversion

In other embodiment, a common style sheet may be used regardless of the display language used after conversion.

(2) Body of data

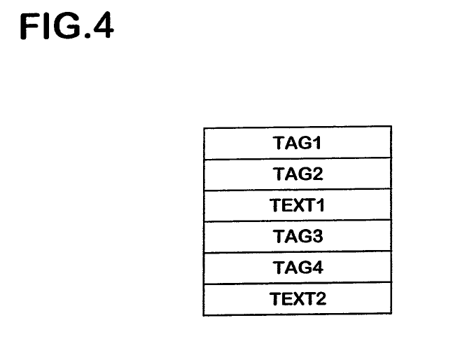

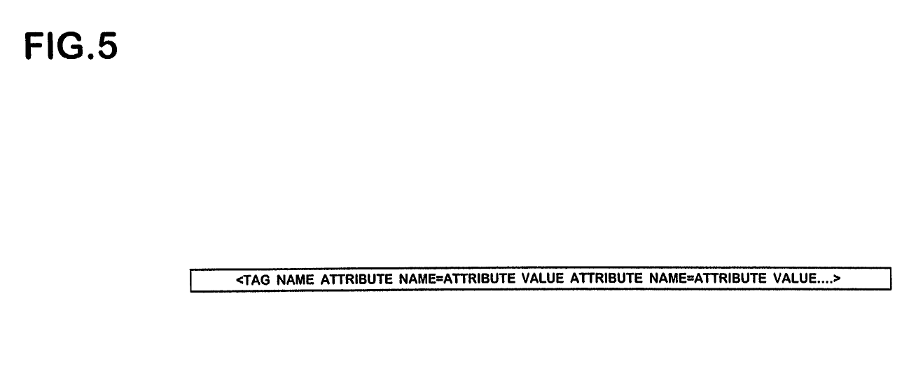

The descriptive structure of a body is shown in FIG. 4. The body comprises tags (parts surrounded by “<” and “>”) and texts (parts other than the tags). The tags, as shown in FIG. 5, start with “<”, then the name of the tags (English characters; essential) and both attributes follow thereafter, and end with “>”. The attributes includes these, the name of the attributes (English characters), “=”, and attribute values (arbitrary characters). Attributes are optionally provided to the data, the data can do without attributes.

Tags start with “<A” (hereinafter referred to as A-tag) and tags start with “”<P” (hereinafter referred to as P-tag) accompany subsequent texts, and end with “</A>” and “/P>” respectively. Conversely, in basic language data, texts only appear right after an A-tag or a P-tag.

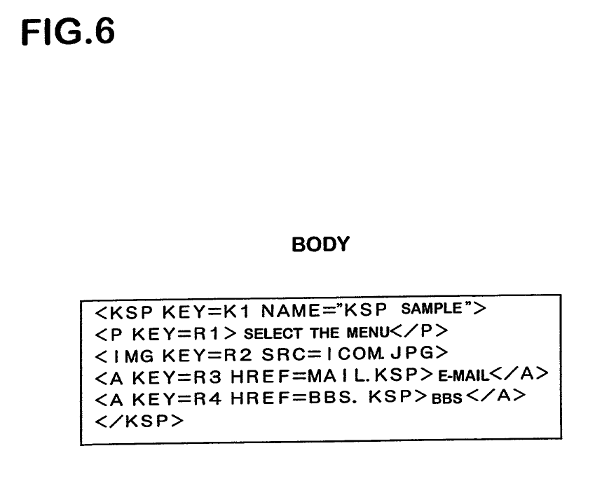

FIG. 6 is a diagram showing an example of the body of basic language data. In this example, a total of three (3) texts such as “select a menu” “E-mail”, and “BBS” are included. On the third line, a file name of image data to be displayed is described after “SRC=”. A link destination is written after “HREF=” on the fourth and the fifth line.

(2) Style sheet

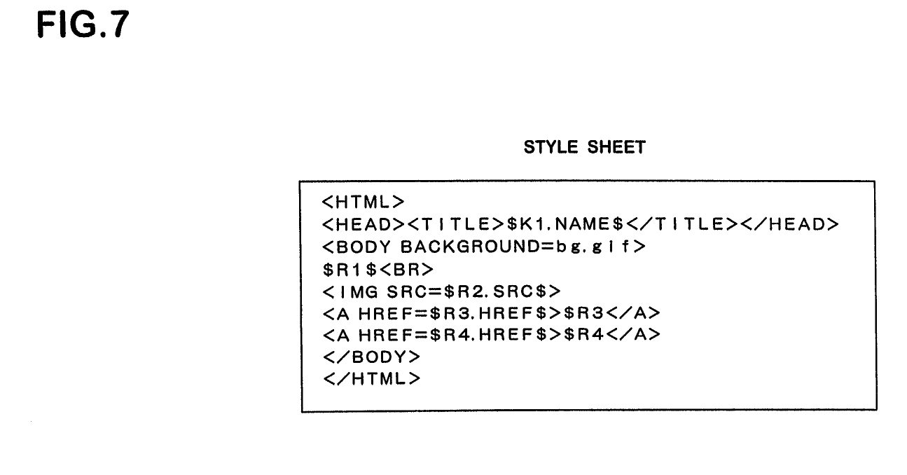

FIG. 7 is a diagram showing an example of a style sheet for HTML corresponding to the body shown in FIG. 6. The description “K1. NAME” located between “$”s on the second line shows that the description on this line indicates a display format of which one of the lines in FIG. 6. The description “K1” shows the name of the tag, so that the first line shown in FIG. 6 corresponds to the description. Interpretation of the style sheet will be described later.

3. Processing performed by the content server 30

(1) Overall processing

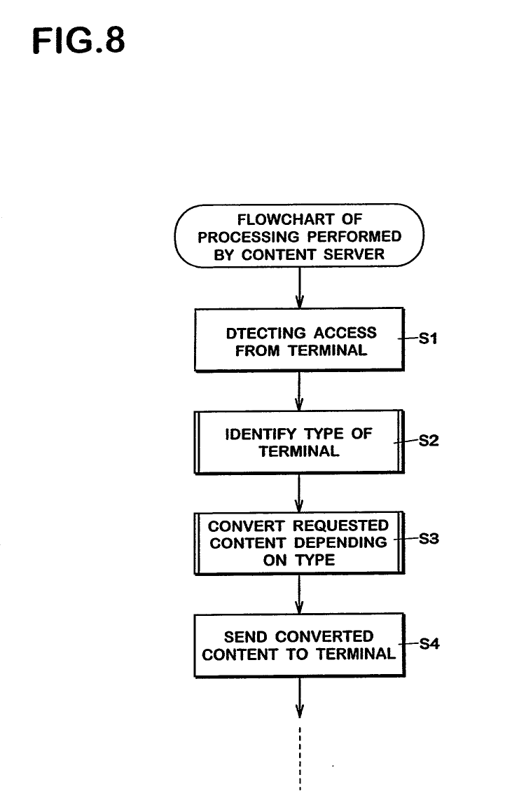

FIG. 8 is a flowchart of the processes performed by the content server 30. When an access from one of the terminals is detected (step S1), the content server 30 identifies the type of the accessing terminal (step S2). The server 30 converts data of the requested content written in the basic language into data written in the display language used by the terminal depending on the type of the terminal thus identified (step S3). Then, the server 30 sends to the terminal the data written in the display language thus converted (step S4). After the transmission, the server 30 continues steps S3 and S4 upon request of the terminals.

As described above, data having appropriate format to the terminal can be returned thereto upon the request from any type of the terminals by just preparing contents written in the basic language.

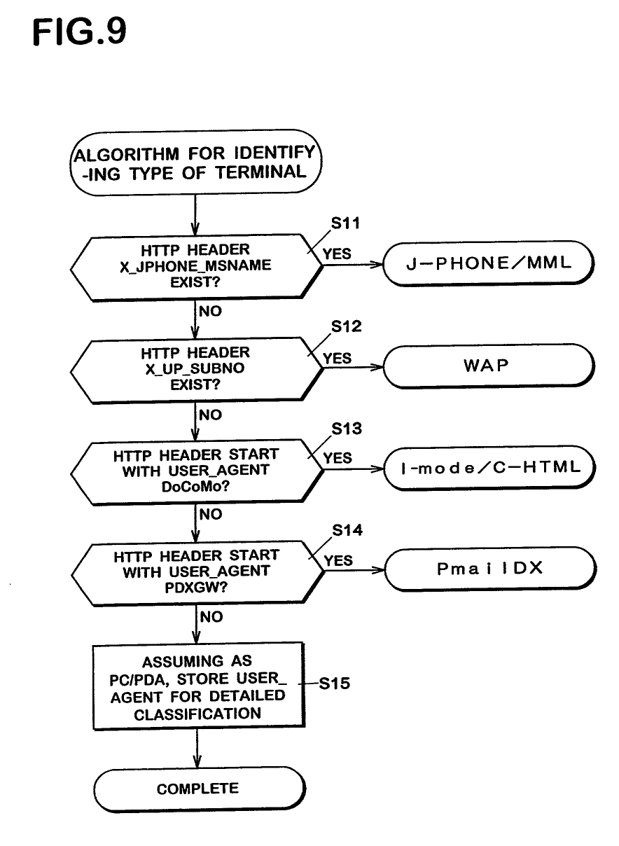

(2) A program for identifying the type of terminals (step S2 in FIG. 9)

FIG. 9 is a flowchart of a program for identifying the type of terminals. When a terminal makes an access to the server 30, an HTTP header is sent thereto from the terminal. The server 30 identifies that the terminal uses HTML when “X_JPHONEMSNAME” is described in the HTTP header (step S11). When “X_UP_SUBNO2” is described in the header, the server judges that a language for the WAP is used for the terminal (step S12). The server 30 judges that terminal uses C-HTML when the description of “USER_AGENT” starts with “DoCoMo” (step S13). When the description of “USER_AGENT” starts with “PDXGW”, the server 30 judges that the terminal uses a language for PmailDX (trademark) (step S14).

When none of above judgements are made, the server 30 judges that the terminal accessing thereto is a PC (step S15). Furthermore, the server 30 judges which one of communication methods such as personal computer communication services, e-mail, HTML, is used in accordance with the description of “USER_AGENT”. The result of the judgement is stored in the memory 36 (see FIG. 2b).

(3) A program for converting a language into another language (step S3 of FIG. 8)

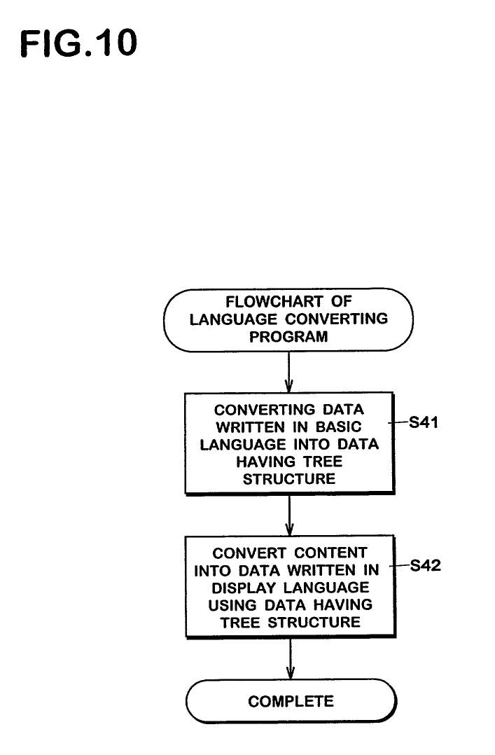

FIG. 10 shows processing for converting content written in the basic language into data written in the display language used by the terminal. At step S41, data of the content written in the basic language is converted into data having a tree structure. Subsequently, the content is converted into data written in a desired display language in accordance with the tree structure data (step S42).

The conversion processing, in which the PC 2 using a browser software makes a request for viewing content written in the basic language, which includes both the style sheet shown in FIG. 7 and the body depicted in FIG. 6, will be described. In this case, the display language used for the terminal can be judged as HTML (see FIG. 9). Hence, the language used for that content need to be converted into HTML eventually.

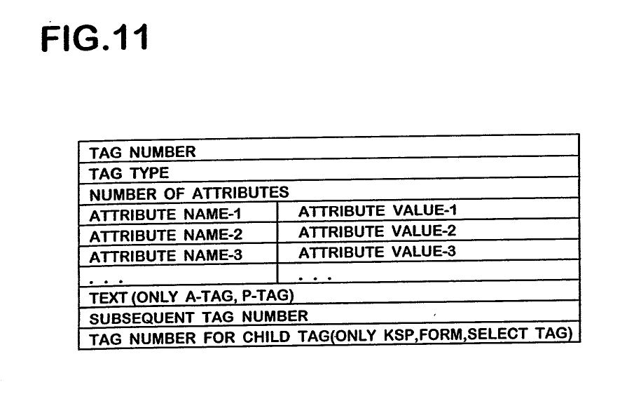

The processing for converting the basic language data into data having a tree structure (step S41) will be described. In order to perform such processing, tags on each line of the body depicted in FIG. 6 are analyzed into the data structure shown in FIG. 11. With regard to subsequent tag number and tag number for child-tags will be described below.

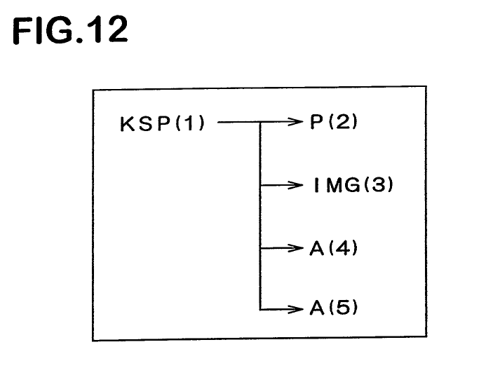

The body depicted in FIG. 6 may express in a tree structure as illustrated in FIG. 12. In the drawing, the numerals within in parentheses indicate tag number. The drawing shows that the entire data of KSP consist of P-tag, IMG-tag, A-tag, and another A-tag.

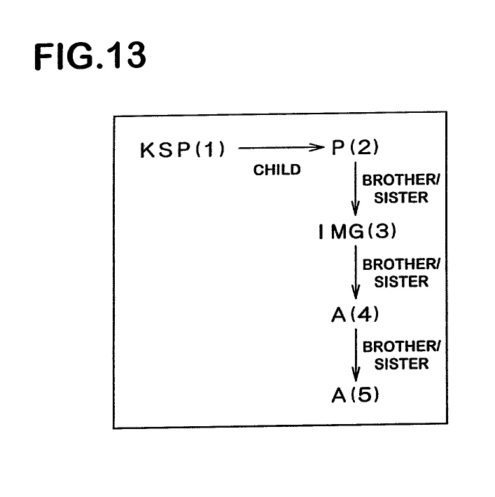

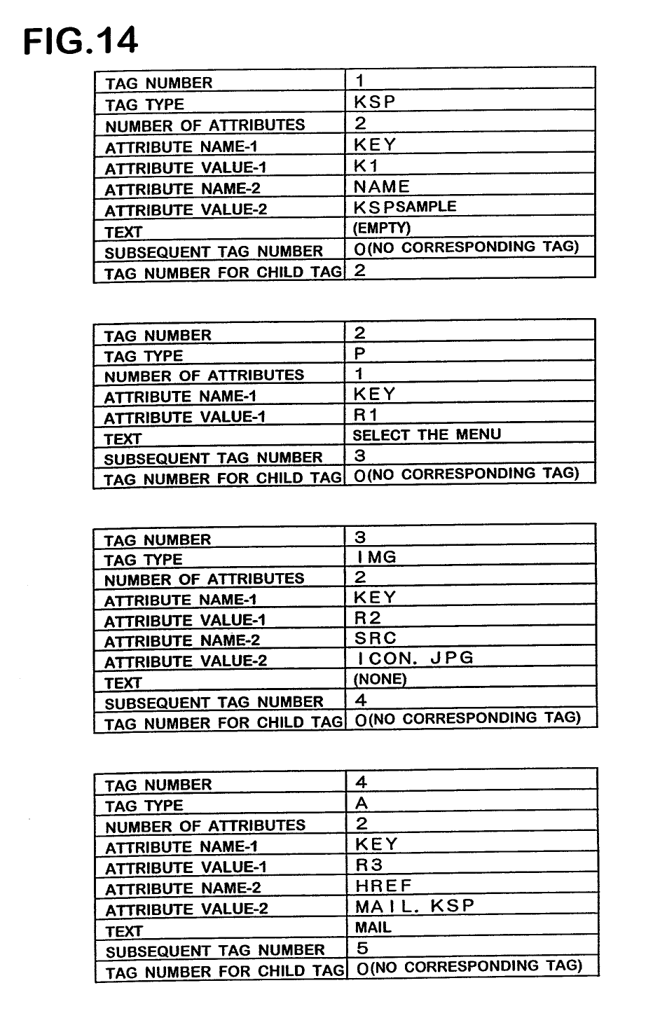

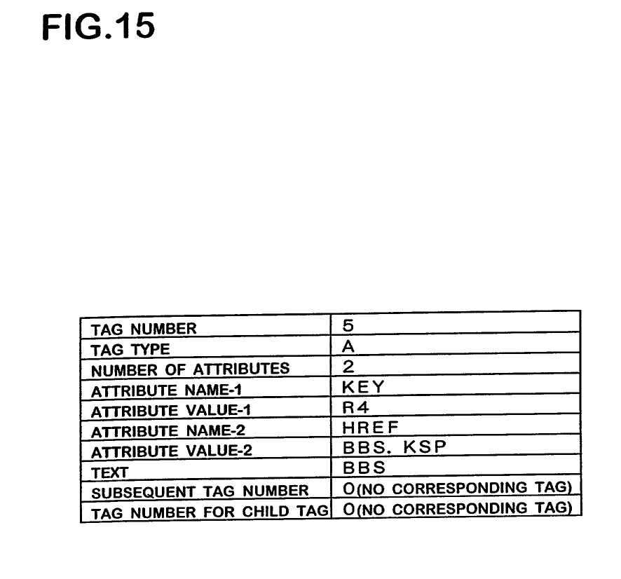

The relationship shown in FIG. 12 may also be expressed as FIG. 13. In other words, the relationship can be expressed using these links, a parent-to-children link indicated in view of parent tag and child-to-child links (brother/ sister links) indicated in view of a highly classified child to a lower classified child having the same parent. In this embodiment, the relationship is expressed in a method shown in FIG. 13. It is, therefore, the body depicted in FIG. 6 is converted into data shown in FIGS. 14 and 15 having a tree structure.

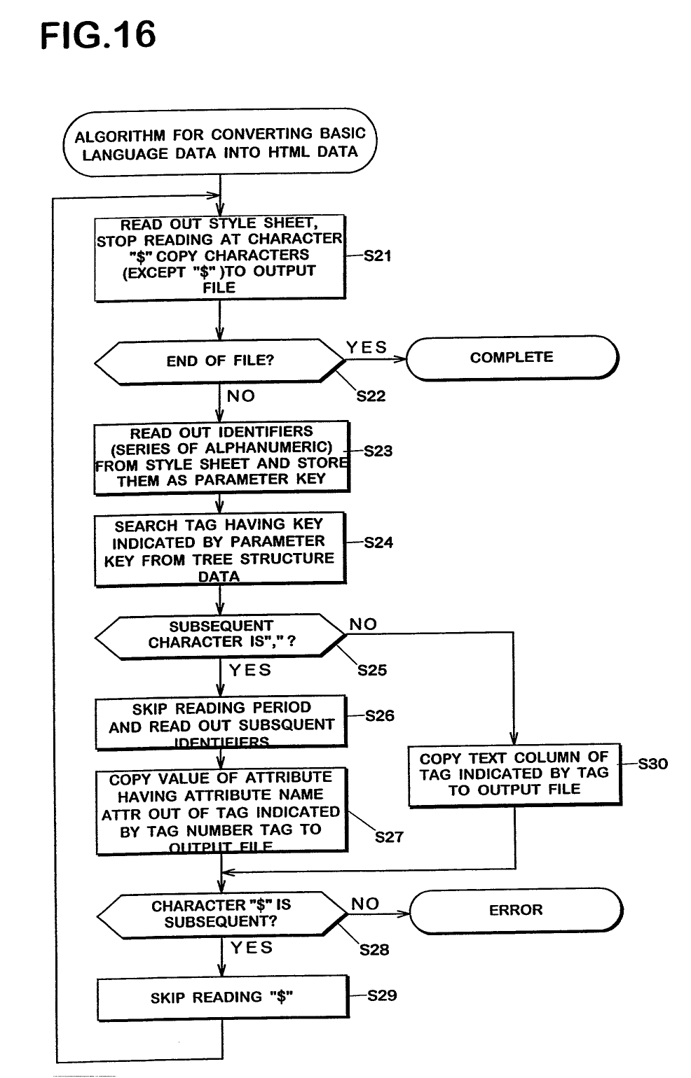

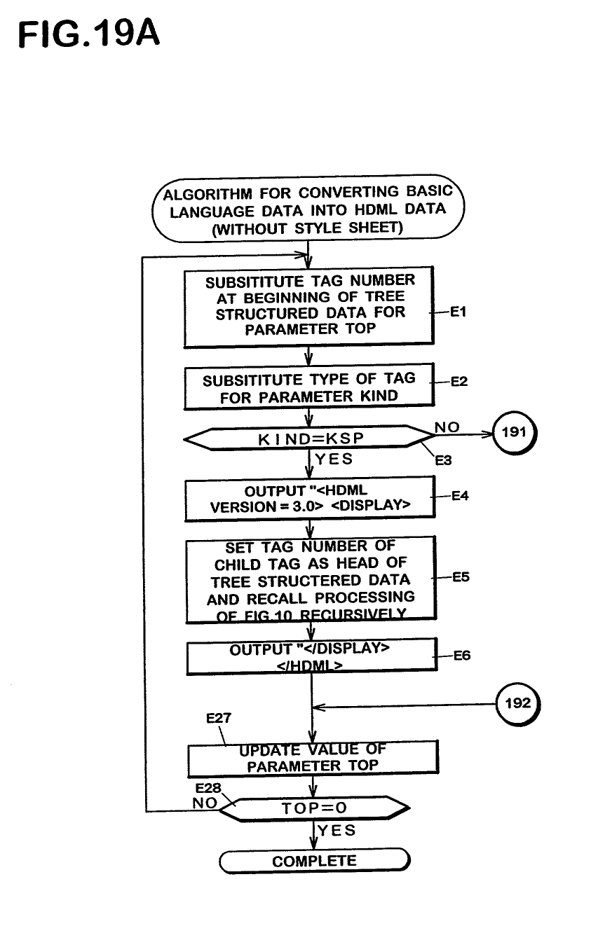

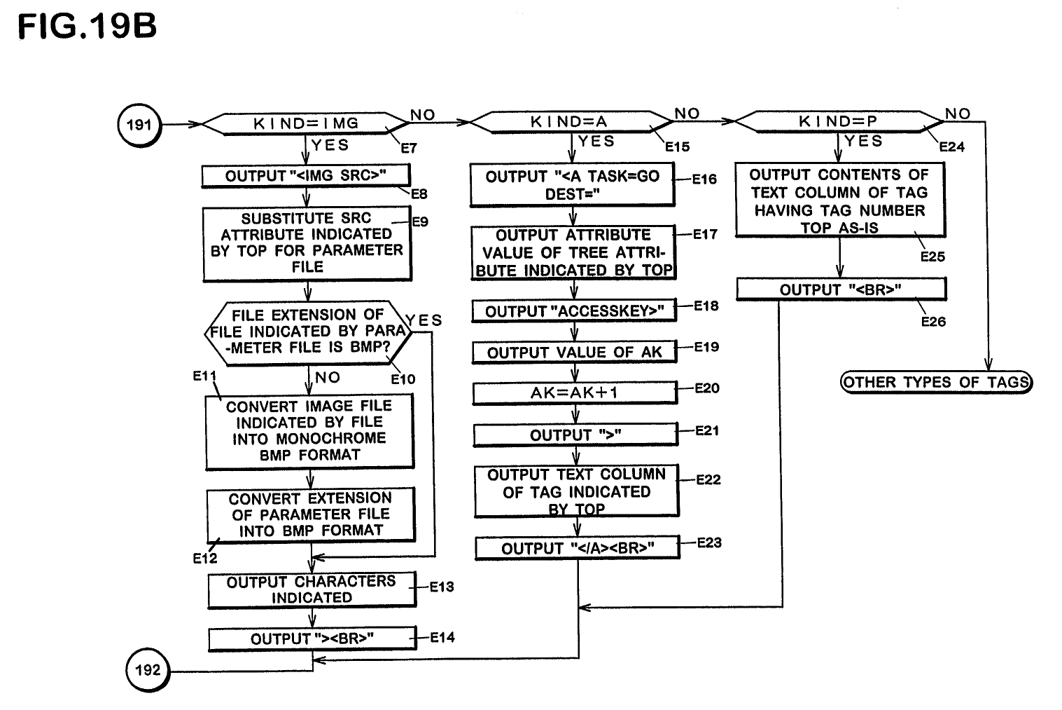

Upon creation of the tree structure data as described above, the original data is converted into data written in the display language using this tree structure data (step S42 of FIG. 10). Flowcharts of such conversion processing are shown in FIGS. 16 and 19a, 19b. FIG. 16 shows converting process in which the display language after the conversion accompanies a style sheet and FIGS. 19a, 19b illustrate another conversion process in which the display language after the conversion does not accompany a style sheet.

This description assumes the conversion into HTML data so that the conversion is performed according to a display format according to a style sheet because HTML data always accompanies a style sheet. Therefore, a program for converting basic language data into HTML data shown in FIG. 16 is performed as described below.

Characters in the style sheet depicted in FIG. 7 are read out sequentially and the characters thus read out until the character “$” are copied on an output file (written in HTML) (step S21). In the case of using the style sheet depicted in FIG. 7, all the characters “<HTML> line feed <HEAD><TITLE>” are copied on the output file. Subsequently, a judgement whether it is the end of the file (end of the style sheet) (step S22). When it reaches to the end of the file, the process ends thereat.

Else, the identifiers (a series of alphanumeric) come subsequent to “$” in the style sheet are read out therefrom. The alphanumeric is stored in the memory 36 as a parameter KEY because the alphanumeric represents a key name assigned to a tag of the basic language data (step S24).

Subsequently, the tag having a key indicated by the parameter KEY is searched from the tree structure data shown in FIGS. 14 and 15 and store the tag number thereof into the parameter TAG (step S24). Here, the value of the parameter TAG is in 1, because tag number 1 has the key name K1.

Next, another judgement, whether or not the subsequent character on the style sheet is a period, is carried out (step S25), if the upcoming character is judged as a period, the content server skip the period from reading, and then identifiers (a series of alphanumeric) subsequent to the period are read out. The alphanumeric thus read out substitutes for a parameter ATTR (step S26). Thereafter, the value of an attribute having attribute name ATTR is copied on the output file from a tag indicated by tag number TAG (step S27). Here, the attribute name ATTR is equivalent to an identifier NAME because the attribute come after the period is the identifier NAME. Thus, the value of the attribute NAME in the tag number 1 such as “KSP sample” is output on the file.

When a judgement in which the subsequent character is not a period, is made at step S25, the text column out of a tag indicated by TAG is copied on the output file (step S30).

Subsequently, another judgement, whether or not the subsequent character is “$”, is carried out (step S28), the content server skip reading it when the subsequent character is “$”(step S29), and then the process goes back to step S21. Else, the server judges that an error occurred and ends the process.

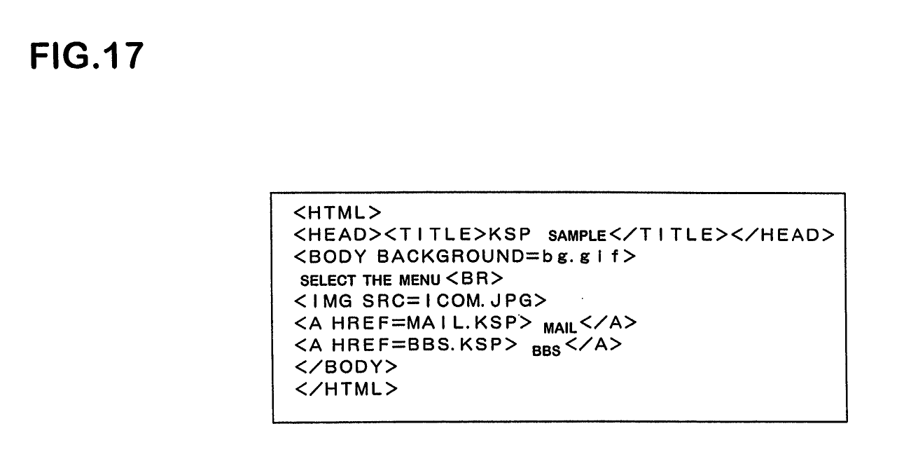

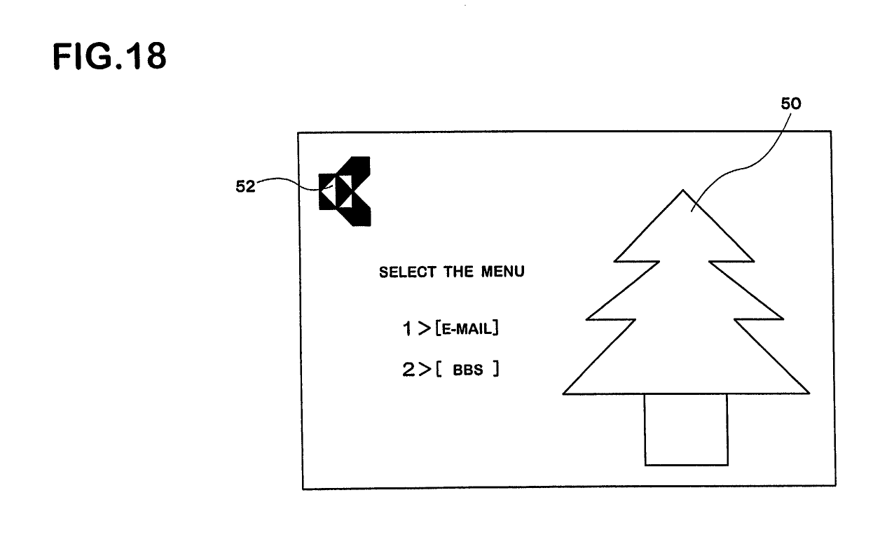

FIG. 17 shows the HTML data thus converted according to the above description. FIG. 18 shows a screen image displayed on the screen of the PC 2 with the HTML data shown in FIG. 17. Wallpaper 50 is displayed with the tag located on the third line. The menu is displayed thereon with the tags located on the fourth, sixth, and seventh lines. It is apparent from the displayed image that images “E-mail”, and “BBS” being underlined are linked in response to tags on the sixth and seventh line. Further, another image 52 is displayed with the tag located on the fifth line.

As described above, the use of a style sheet let the server obtains pure HTML data. In addition, the style sheet allows these in display: decorative work such as creating tables, centering, right-justify, blinking, as well as banner advertising, icons.

Although, data conversion in language from the basic language to HTML has been described in the above description, programs for converting basic language data written into data in other display languages are stored in the server so that a conversion program appropriate to a terminal will automatically selected and used depending on the type of the terminals.

Subsequently, processing performed by the server when a request for viewing a content stored therein is output from the WAP terminal 6 (mobile phone) will be described. In this case, the algorithm shown in FIG. 9 is also used for identifying the type of a terminal. With this algorithm, it is known that the basic language data need to be converted into HDML data.

Exactly the same processing to the processing described in the above is performed until converting the basic language data into data in a tree structure as shown in FIG. 10. However, the program shown in FIGS. 19a, 19b is executed because no style sheet for HDML data exist in the basic language data illustrated in FIGS. 6 and 7.

In the program, tag number of the tag located at the beginning of the tree structured data shown in FIGS. 14 and 15 is acquired and is substituted for a parameter TOP (step E1). Here, the value of the parameter TOP is equal to 1 because an element located at the beginning thereof is tag number 1. Then, the type of tag indicated by the parameter TOP is fetched and is substituted for a parameter KIND (step E2). Here, it is, therefore, the parameter KIND is equivalent to “KSP”.

Thereafter, the process is branched depending upon contents of the parameter KIND (step E3). Here, the process proceeds at step E4 because the parameter is equal to “KSP”.

At step E4, characters “<HDML VERSION=3.0><line feed><DISPLAY>”are output as header information of HDML on the file. Then, the tag number of a child tag for the TAG number 1 is set as the beginning of the tree structured data, and the processing shown in FIG. 10 is recalled recursively (step E5). In this case, the parameter TOP comes to 2 at step E1 and the parameter KIND is in “P” at step E2.

Thus, the process proceeds at steps E24 and E25 from step E3 through steps E7, E15. At step E25, contents of the text column of a tag, its tag number being TOP, is output as it is. Here, a text column “select the menu” is output to the file. Subsequently, a tag “<BR>” is output for line feed. (step E26).

Next, the process proceeds to step E27, and the value of a column “subsequent tag number” of the parameter TOP is substituted for the parameter TOP. Here, the value of the parameter TOP is equal to 3. Subsequently, a judgement whether or not the parameter TOP is equal to 0 is carried out (step E28). In this case, the process returns to step E2 because the parameter TOP is not 0.

Thereafter, the type of a tag indicated by the parameter TOP is identified at step E3. In this case, the process proceeds to step E8 from step E7 because the parameter KIND is equivalent to “IMG”. At step E8, an HDML tag indicating images <IMG SRC> is output (step E8). Subsequently, the name of an image file is obtained by using the SRC attribute of a tag indicated by the parameter TOP and the SRC attribute is substituted for a parameter FILE (step E9). In this case, the parameter FILE is equal to “ICON. JPG”. Then, steps following with step E11 are executed when the parameter FILE is not “BMP” as a result of carrying out a search for a file extension of a file indicated by the parameter FILE (step E10). On the contrary, the process proceeds to step E13, when the file extension is in “BMP”. In this case, the steps following with step El 1 will be executed because the extension is “JPG” indicating JPEG images, not “BMP”.

Images in “ICON. JPG” are converted into images in a monochrome BMP format at step E11. Next, the extension of the parameter FILE is converted into “BMP” from “JPG”(step E12). It is, therefore, the parameter FILE becomes “ICON. BMP”.

Subsequently, characters indicated by the parameter FILE are output (step E13). Further, an ending tag of the images and a tag for line feed “></BR>” are output (step E14).

Thereafter, the value of the parameter TOP is updated (step E27). In this case, the parameter TOP becomes 4 so that the process proceeds to step E2 through step E28, and the parameter KIND is equal to A thereat. Thus, the process proceeds to step E16 through steps E3, E7 and E15.

At step E16, an HDML tag “A TASK=GO DEST=” representing hyperlink is output to the file (step E16). Subsequently, an HREF attribute of a tag indicated by the parameter TOP is searched and the value of the attribute is output (step E17). In this case, the value thus output is “MAIL.KSP”.

Next, after a tag “ACCESSKEY=” is output (step E18), the value of a parameter AK is incremented by 1 (step E20). Here, the tag ACCESSKEY is a tag for accelerating operation performed with numeric keypads on the mobile phones, generally a series of numerals used more than one.

Thereafter, the A-tag is finalized by outputting a character “>” (step E21), and the text column of a tag indicated by the parameter TOP is output (step E22). In this case, “mail 1” is written in the text column. Then, the A-tag is closed with characters “</A><BR>” (step E23).

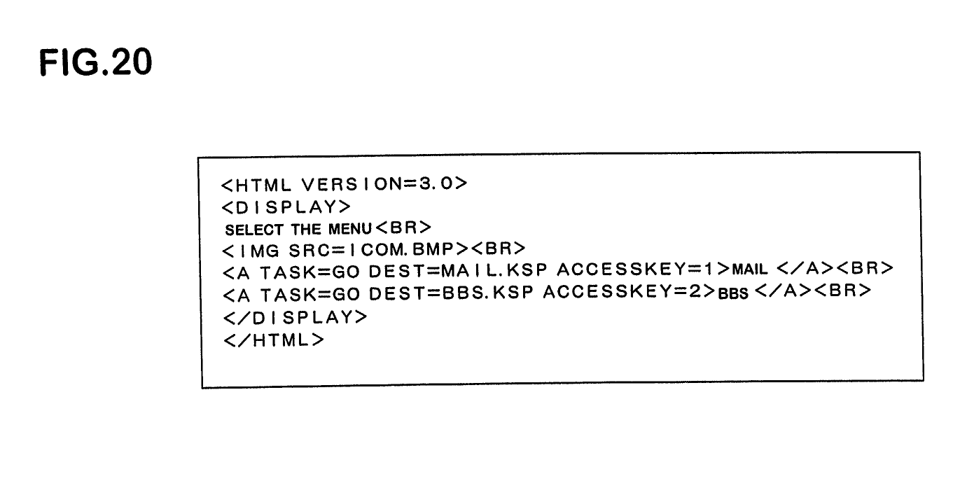

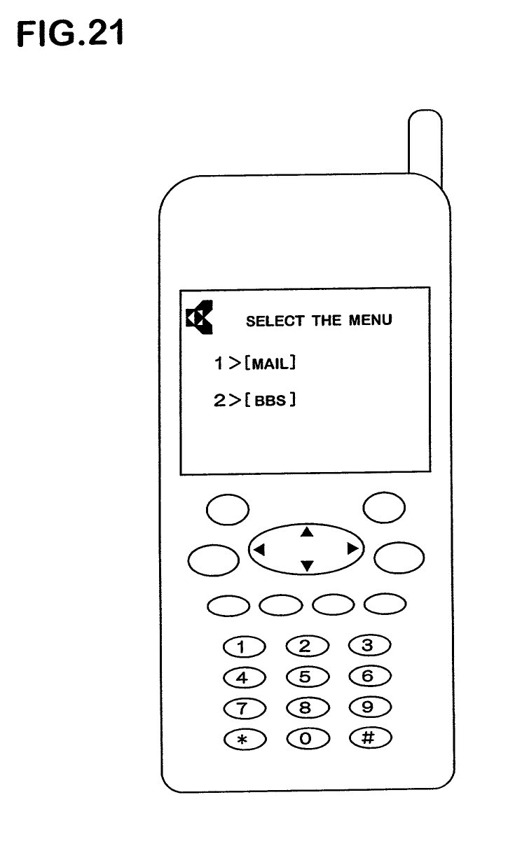

As described above, HDML data, the resultant data of conversion, is obtained as an output file. Thus, conversion of display language into the standard display format is performed when no style sheet for its display language exists in the basic language data. HDML data, the resultant data, is illustrated in FIG. 20. FIG. 21 shows an example of an image of the HDML data displayed on the screen of the WAP terminal 6.

Although, the conversion into HDML data from the basic language data have been described in the above, other programs for language conversion into other display languages are stored in the server so that an appropriate program for conversion is automatically selected and used depending on the type of the terminal accessing the server.

The basic method of converting a language used by an accessing terminal into anther display language employed in the programs is similar to that described in the above. But no function of requiring a link destination is equipped with the terminal when the terminal use a protocol for E-mail and the terminal is used for personal computer communications service. Thus, the current status of the terminal and the link destination after the selection (the transition destination) need to be managed by the server 30. In order to fulfill this requirement, it is necessary for the server not only creating display language data but also managing the status of the terminal, and to create data that can be used for determining the link destination when the link destination is described in the basic language data.

In this embodiment, the conversion is performed on a real time basis whenever the terminal requires it. In this way, update of the content can immediately reflect of the display thereof on the terminal whenever the content is updated

In this embodiment, content data written in the basic language is stored in the server, and the data is converted into display language data written in a language appropriate to the type of a terminal accessing to the server. In this way, content can be viewed on every terminal by just preparing contents written in the basic language.

An elliptical symbol indicating a predetermined display format may be used as a description in the style sheet in the embodiment described above. In this way, the description for display formats frequently used can be simplified. In addition, conversion of such data can also be accelerated.

4. Other embodiments

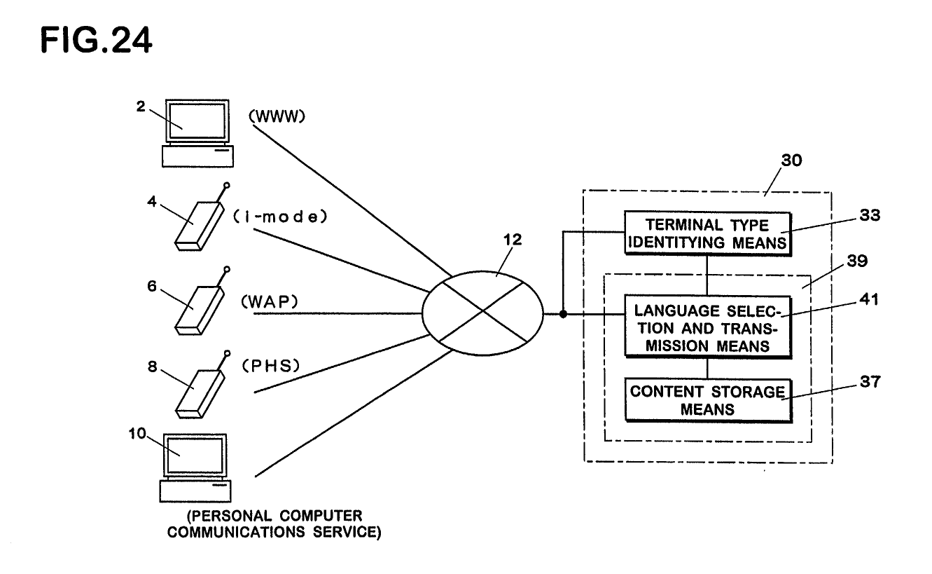

(1) FIG. 24 is a diagram showing the content distribution system of another embodiment of the present invention in. The content server 30 in this embodiment differ from the one in the previous embodiment in that the terminal support processing means 39 comprises language selecting and transmission means 41 and the content storage means 37. Content written in display languages for all the terminals, not written in the basic language, have been created previously and stored in the content storage means 37. The transmission means 41 receives the type of a terminal accessing and content written in a language appropriate to the type of the terminal is transmitted thereto.

According to this embodiment, system's operation can be expedited without providing content servers for each of the display languages.

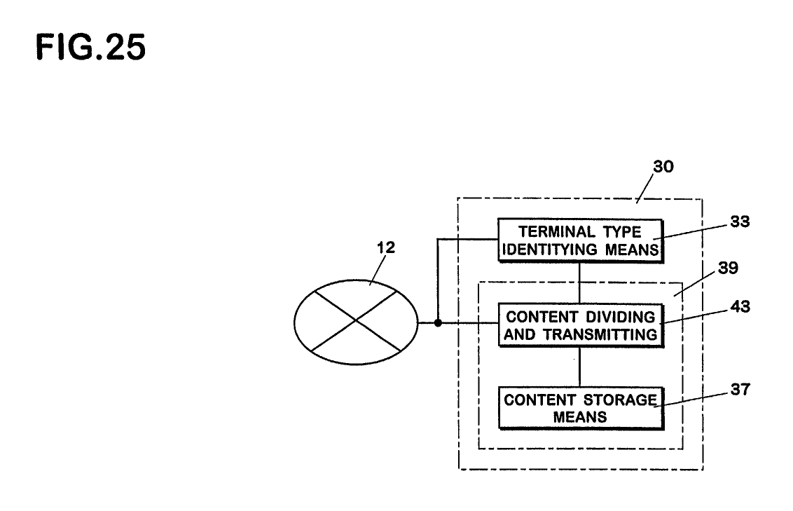

(2) FIG. 25 is a diagram showing the content distribution system of another embodiment of the present invention. The content server 30 in this embodiment differ from the ones in the previous embodiments in that the terminal support processing means 39 comprises content dividing and transmitting means 43 and the content storage means 37.

The capacity capable of the terminal for storing the terminals for storing content at a time is different from one another depending on its type. Therefore, the content need to be divided into several portions and transmit them when a terminal having a small storage capacity is used. The content dividing and transmitting means 43 receives a signal indicative of the type of the terminal from the terminal type identifying means 33 and transmits to the terminal the content divided into a size appropriate to the storage capacity of the terminal.

In this way, creators of the content do not have to take account of the storage capacity of each terminal when they create the content. The system according to the embodiment shown in FIG. 25 may be operated in combination with the system shown in FIGS. 2a and 24.

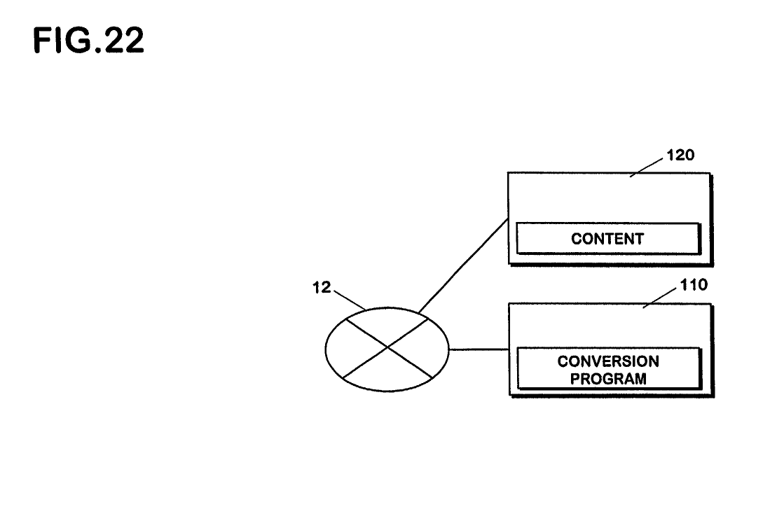

(3) The processing for converting content is performed within the content server 30 in the embodiments described above. Alternatively, both a content server 120 storing the content written in the basic language and a converting server 110 storing a program for the conversion and performing conversion processing may be provided independence of each other as shown in FIG. 22.

In order to distribute the load (or providing a backup server) as a result of independently providing the servers, the administrator of the system just provides two of the converting servers 110 so that the administrator is free from preparing two identical contents. In this way, maintenance of the contents can be simplified.

(4) Although, the conversion is performed on a real time basis in the descriptions stated above, content which have been converted with the program for conversion may be provided. Alternatively, the conversion may be performed on a real time basis in accordance with the data converted into the tree structure shown in FIGS. 14 and 15, which have been stored in the server.

(5) The type of the terminal (both in hardware and software) accessing is identified by HTTP header in the embodiments described above. Such identification may also be done with its IP address.

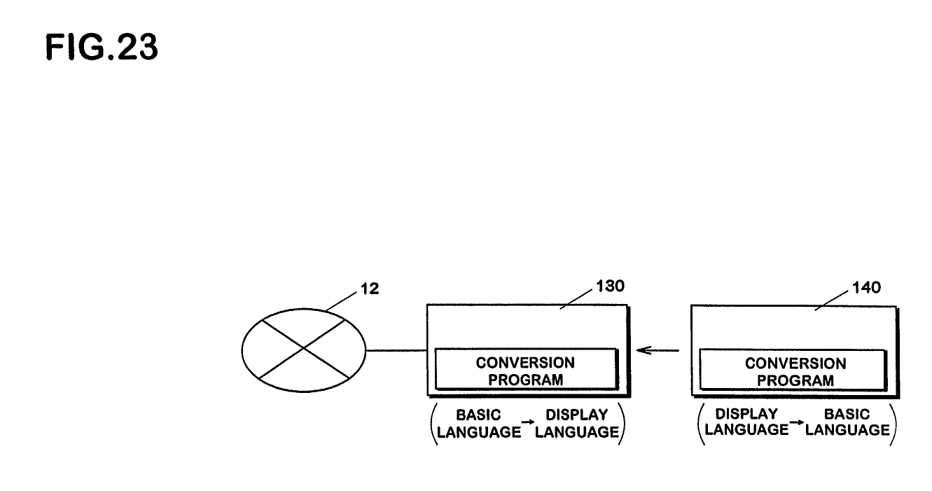

(6) In the embodiments described above, content written in the basic language is stored, and such content is converted into content written in a display language for the terminal. However, the content written in a desired display language can be obtained by performing the processing with a system shown in FIG. 23 in which all the display languages for the terminals are converted once into the basic language using a first converting device 140 storing a first conversion program and then the converted content in the basic language is converted into the content written in the desired language using a second conversion device 130 storing a second conversion program. In this way, contents written in any display language can be viewed on all the terminals.

In addition, both the converting devices 130 and 140 may perform the conversion on a real time basis, or they may store the resultant data after performing the conversion thereby.

(7) Displays on the screen have been used an output format of the content in the embodiment described above, the present invention can also be applied to other output formats such as an audio based output.

(8) The term “terminal support processing means” in the above described embodiments refers to any means by which contents provided to the terminals can be changed depending on the type of the terminal. For example, means by which details of content such as a language used therefor and its size and so on are changed and the resultant content is transmitted to the terminal as described in the embodiments herein.

While the embodiments of the present invention, as disclosed herein, constitute preferred forms, it is to be understood that each term was used as illustrative and not restrictive, and can be changed within the scope of the claims without departing from the scope and spirit of the invention.

What is claimed is:

1. A content distribution system comprising a content distribution server, the server transmitting content upon receipt of an access to the system from different types of terminal devices,
wherein the content is stored in the content distribution server, and the system identifies a type of the terminal device which have requested for the content along with changing contents of processing by which the content is distributed depending on the type of the terminal when the content distribution processing is performed according to the stored content.

2. A content server receiving accesses from terminal devices, each using different display language, the content server comprising:
content storage means, storing content created by data written in a basic language;
terminal type identifying means, identifying a type of the terminal device accessing to the server; and
language conversion and transmission means, reading out the content stored in the content storage means, converting the display language used for the content into an appropriate display language for performing display on the terminal device, and transmitting the converted content to the terminal device.

3. A program for realizing a content server receiving an access by different types of terminal devices with a computer the content server comprising:
content storage means, storing content created by data written in a basic language;
terminal type identifying means, identifying a type of the terminal device accessing to the server; and
language conversion and transmission means, reading out the content stored in the content storage means, converting the display language used for the content into an appropriate display language for performing display on the terminal device, and transmitting the converted content to the terminal device.

4. A storage medium to store a program for realizing a content server receiving an access by different types of terminal devices with a computer, the content server comprising:
content storage means, storing content created by data written in a basic language;
terminal type identifying means, identifying a type of the terminal device accessing to the server; and
language conversion and transmission means, reading out the content stored in the content storage means, converting the display language used for the content into an appropriate display language for performing display on the terminal device, and transmitting the converted content to the terminal device.

5. The content server of claim 2 wherein the terminal type identifying means identifies the type of the terminal device in accordance with an header of Hyper Text Transfer Protocol (HTTP) sent from the terminal.

6. The content server of claim 2 wherein the terminal type identifying means identifies the type of the terminal device in accordance with an IP address of the terminal device when it accesses to the server.

7. The content server of claim 2 wherein information in the data written in the basic language which is required for performing display on the terminal device is separated into display contents description data indicative of what is to be displayed and display format description data indicative of a display format of the display,
and wherein the data written in the basic language includes at least the display contents description data and the display format description data necessary for performing display.

8. The content server of claim 7 wherein the display format description data includes description indicating a display format of each of the display contents corresponding to each of the display contents described in the display contents description data.

9. The content server of claim 8 wherein the description indicating the display format includes an elliptical symbol, which shows that the description is a predetermined display format.

10. A method of distributing content on receipt of an access to the system from different types of terminal devices, the method comprising the steps of:
storing the content;
identifying a type of the terminal device which have requested for the content; and
changing contents of processing by which the content is distributed depending on the type of the terminal when the content distribution processing is performed according to the stored content.

11. A language conversion system for converting one arbitrary display language referring to as a conversion source display language out of different display languages used for performing display on different types of terminal devices into another arbitrary display language, the system comprising:
display language data storage means, storing data written in the conversion source display language;
first conversion processing means, converting the data written in the conversion source display language stored in the display language data storage means into data written in a basic language, the first conversion processing means separating the conversion source display language data into display contents description indicative of what is to be displayed and display format description indicative of a display format of the display as a result of performing an analysis of the data written in the conversion source display language, and the data written in the basic language including at least display contents description data and the display format description data necessary for performing display;
basic language data storage means, storing the data written in the basic language; and
second conversion processing means, generating another display language data by determining display contents according to the display contents description data in the data written in the basic language stored in the basic language data storage means and by determining the display format according to the display format description data.

12. A language conversion system for converting different display languages used for performing display on different types of terminal devices into a basic language, the system comprising:
display language data storage means, storing data written in the display languages; and
conversion processing means, converting the data written in the display language stored in the display language data storage means into data written in written in the basic language;
wherein the conversion processing means separates the data written in the display language into display contents description indicative of what is to be displayed and display format description indicative of a display format of the display as a result of performing an analysis of the data written in the display language, and the data written in the basic language includes at least display contents description data and display format description data necessary for performing display.

13. A storage medium to store a program for realizing a language conversion system for converting different display languages used for performing display on different types of terminal devices into a basic language with a computer, the system comprising:
display language data storage means, storing data written in the display languages; and
conversion processing means, converting the data written in the display language stored in the display language data storage means into data written in written in the basic language;
wherein the conversion processing means separates the data written in the display language into display contents description indicative of what is to be displayed and display format description indicative of a display format of the display as a result of performing an analysis of the data written in the display language, and the data written in the basic language includes at least display contents description data and display format description data necessary for performing display.

14. A program for realizing a language conversion system for converting different display languages used for performing display on different types of terminal devices into a basic language with a computer, the system comprising:
display language data storage means, storing data written in the display languages; and
conversion processing means, converting the data written in the display language stored in the display language data storage means into data written in written in the basic language;
wherein the conversion processing means separates the data written in the display language into display contents description indicative of what is to be displayed and display format description indicative of a display format of the display as a result of performing an analysis of the data written in the display language, and the data written in the basic language includes at least display contents description data and display format description data necessary for performing display.

15. The language conversion system of claim 12 wherein the conversion processing means generates data written in the basic language not including the display format description data when the display format of a display language which to be converted is in a basic display format.

16. The language conversion system of claim 15 wherein the display format description data includes description indicating a display format of each of the display contents corresponding to each of the display contents described in the display contents description data.

17. The language conversion system of claim 16 wherein the description indicating the display format includes an elliptical symbol, which shows that the description is a predetermined display format.

18. A method of converting data written in a language for output which is subject to conversion into data written in a basic language, the method being used for converting data written in different languages for output by different types of devices into data written in one common basic language, the method comprising the step of
separating the data written in the output language into output contents description indicative of what is to be output and output format description indicative of an output format of the output data as a result of performing an analysis of the data written in the output language, and the data written in the output language including at least output contents description data and output format description data necessary for performing output.

19. A language conversion system for generating data written in multiple different languages for performing display on different types of terminal devices according to one basic language, the system comprising:
basic language data storage means, storing data written in the basic language; and
conversion processing means, converting the data written in the basic language data stored in the basic language data storage means into data written in the display language;
wherein information in the data written in the basic language which is required for performing display on the terminal device is separated into display contents description data indicative of what is to be displayed and display format description data indicative of a display format of the display,
and wherein the data written in the basic language includes at least the display contents description data and the display format description data necessary for performing display.

20. A storage medium to store a program for realizing a language conversion system for generating data written in multiple different languages for performing display on different types of terminal devices according to one basic language with a computer, the system comprising:
basic language data storage means, storing data written in the basic language; and
conversion processing means, converting the data written in the basic language data stored in the basic language data storage means into data written in the display language;
wherein information in the data written in the basic language which is required for performing display on the terminal device is separated into display contents description data indicative of what is to be displayed and display format description data indicative of a display format of the display,
and wherein the data written in the basic language includes at least the display contents description data and the display format description data necessary for performing display.

21. A program for realizing a language conversion system for generating data written in multiple different languages for performing display on different types of terminal devices according to one basic language with a computer, the system comprising:
basic language data storage means, storing data written in the basic language; and
conversion processing means, converting the data written in the basic language data stored in the basic language data storage means into data written in the display language;
wherein information in the data written in the basic language which is required for performing display on the terminal device is separated into display contents description data indicative of what is to be displayed and display format description data indicative of a display format of the display,
and wherein the data written in the basic language includes at least the display contents description data and the display format description data necessary for performing display.

22. The language conversion system of claim 19 wherein the conversion processing means carries out the conversion so that a display format of the data is in a standard display format in the display language to be converted when no display format description data is included in the data written in the basic language.

23. The language conversion system of claim 19 wherein the display format description data includes description indicating a display format of each of the display contents corresponding to each of the display contents described in the display contents description data.

24. The language conversion system of claim 23 wherein the description indicating the display format includes an elliptical symbol, which shows that the description is a predetermined display format.

25. A method of converting data written in a basic language being retrieved which is subject to conversion into data written in a language for output, the method being used for converting the data written in the basic language into data written in different kind of languages for outputting by different types of terminal devices according to one basic language,
wherein information, contained in the data written in the basic language which is required for performing output by the terminal device, is separated into output contents description data indicative of what is to be output and output format description data indicative of an output format,
and wherein the data written in the basic language includes at least output contents description data and output format description data necessary for performing output.

26. Data written in a basic language which is used as basic data for converting data into data written in multiple different languages for performing output by different types of terminal devices, the medium following parts:
an output contents description part, describing output contents of the data; and
an output format description part, describing an output format of the output contents.

27. A storage medium to store the data written in the basic language defined in claim 26.
